(19) United States
(12) Patent Application Publication
(10) Pub. No.: US 2021/0227173 A1
(43) Pub. Date: Jul. 22, 2021

(54) IMAGE DATA PROCESSING METHOD, DATA TRANSMISSION APPARATUS, IMAGE DISPLAY METHOD AND STORAGE MEDIUM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Lin LIN, Beijing (CN); Jian SUN, Beijing (CN); Ziqiang GUO, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/632,933

(22) PCT Filed: Jan. 4, 2019
(86) PCT No.: PCT/CN2019/070459

§ 371 Date: Jan. 22, 2020

(51) Int. Cl. H04N 7/04; G06F 3/14

(52) U.S. Cl. CPC H04N 7/04; G06F 3/14

(57) ABSTRACT

An image data processing method, an image display method, a data transmission apparatus and a storage medium. The image data processing method includes: storing an object data set to be transmitted into a first cache space, in which the object data set includes N pieces of consecutive image data sequentially arranged in a first order; recombining the N pieces of consecutive image data into M data subsets, in which each data subset includes N/M pieces of image data which are not adjacent to each other, sequentially selected from the N pieces of consecutive image data according to a first rule; and transmitting the M data subsets. And M is an integer greater than 1, and N is an integer multiple of M and greater than M.

### TECHNICAL FIELD

Embodiments of the present invention relate to an image data processing method, an image display method, a data transmission apparatus and a storage medium.

### BACKGROUND

Data communication is a communication mode produced by a combination of communication technologies and computer technologies. For example, depending on different transmission mediums, the data communication may include wired data communication and wireless data communication. For example, they all connect data terminals with computers through transmission channels, so that data terminals at different positions may implement the share of software, hardware and information resources.

### SUMMARY

At least one embodiment of the present disclosure provides an image data processing method, which includes: storing an object data set to be transmitted into a first cache space, in which the object data set comprises N pieces of consecutive image data sequentially arranged in a first order, recombining the N pieces of consecutive image data into M data subsets, in which each data subset comprises N/M pieces of image data which are not adjacent to each other, sequentially selected from the N pieces of consecutive image data according to a first rule, and transmitting the M data subsets. M is an integer greater than 1, and N is an integer multiple of M and greater than M.

For example, in the image data processing method provided by at least one embodiment of the present disclosure, the N pieces of consecutive image data sequentially arranged in the first order comprises N pieces of consecutive image data sequentially arranged in an order from a 1st piece to an Nth piece.

For example, the image data processing method provided by at least one embodiment of the present disclosure further includes: receiving the transmitted M data subsets, and extracting image data included in each of the M data subsets to a second cache. space. The N pieces of consecutive image data sequentially arranged in the first order is recovered based on the first rule in the second cache space.

For example, in the image data processing method provided by at least one embodiment of the present disclosure, after the N pieces of consecutive image data sequentially arranged in the first order is recovered based on the first rule in the second cache space, each piece of data in the second cache space is checked, and if image data with transmission error or lost image data occurs, according to an interpolation method, the image data with transmission error is modified or the lost image data is filled.

For example, in the image data processing method provided by at least one embodiment of the present disclosure, the first rule comprises: cyclically selecting the data subset with a period of L, in which L is an integer greater than 1.

For example, in the image data processing method provided by at least one embodiment of the present disclosure, the first cache space is a matrix cache space, and the matrix cache space comprises L*M pieces of image data.

For example, in the image data processing method provided by at least one embodiment of the present disclosure, selecting cyclically the data subset with the period of L comprises: in a column reverse order, outputting sequentially image data in a Mth column, a (M−1)th column, . . . , a (M−i)th column, . . . , and a 1st column of the matrix cache space as the data subset, respectively. Each column comprises L pieces of image data which are not adjacent to each other, and i is an integer greater than 1 and less than M.

For example, in the image data processing method provided by at least one embodiment of the present disclosure, after Lth image data in the (M−i)th column is written into the matrix cache space, image data in the (M−i)th column is output in parallel.

For example, in the image data processing method provided by at least one embodiment of the present disclosure, when the image data in the (M−i)th column is output in parallel, a parallel-to-serial conversion operation is performed on image data in a [M−(i−1)]th column so as to convert the image data in the [M−(i−1)]th column into serial data.

At least one embodiment of the present disclosure further provides an image display method, which includes: acquiring pixel data of an image to be displayed, transmitting the pixel data of the image to be displayed row by row using the image data processing method provided by any one embodiment above of the present disclosure, and outputting the pixel data row by row to a display panel for display.

At least one embodiment of the present disclosure further provides a data transmission apparatus, which includes: a cache unit, configured to store an object data set to be transmitted into a first cache space, in which the object data set comprises N pieces of consecutive image data sequentially arranged in a first order, a data subset selecting unit, configured to recombine N pieces of consecutive image data into M data subsets, in which each data subset comprises N/M pieces of image data which are not adjacent to each other, sequentially selected from the N pieces of consecutive image data according to a first rule, and a transmitting unit, configured to transmit the M data subsets. M is an integer greater than 1, and N is an integer multiple of M and greater than M.

For example, the data transmission apparatus provided by at least one embodiment of the present disclosure further includes: a reading unit, configured to receive the transmitted M data subsets, and extract image data included in each of the M data subsets to a second cache space. And the N pieces of consecutive image data sequentially arranged in the first order is recovered based on the first rule in the second cache space.

For example, the data transmission apparatus provided by at least one embodiment of the present disclosure further includes: a checking unit, configured to check each piece of image data in the second cache space, after the N pieces of consecutive image data sequentially arranged in e first order is recovered based on the first rule in the second cache space, and to modify image data with transmission error or fill lost image data according to an interpolation method, if the image data with transmission error or the lost image data occurs.

At least one embodiment of the present disclosure further provides a data transmission apparatus, which includes: a processor, a memory, and one or more computer program modules stored in the memory and configured to be executed by the processor. And the one or more computer program modules includes instructions for implementing the image data processing method according to any one embodiment of the present disclosure.

At least one embodiment of the present disclosure further provides a storage medium, which stores non-transitorily computer readable instructions that, when executed by a computer, cause to perform the instructions of the image data processing method according to any one embodiment of the present disclosure.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative of the disclosure.

FIG. 1 is a matrix representation of pixel data of an image to be displayed;

FIG. 2 is a schematic diagram of a serial data stream corresponding to the 1st row of pixel data illustrated in FIG. 1;

FIG. 3 is a flowchart of an image data processing method provided by some embodiments of the present disclosure;

FIG. 4 is a storage schematic diagram of a first cache space provided by some embodiments of the present disclosure;

FIG. 5 is a schematic diagram of an extraction data subsets and parallel-to-serial conversion operation provided by some embodiments of the present disclosure;

FIG. 6 is a schematic diagram of serial transmission of M data subsets provided by some embodiments of the present disclosure;

FIG. 7 is a flowchart of another image data processing method provided by some embodiments of the present disclosure;

FIG. 8 is a flowchart of an image display method provided by some embodiments of the present disclosure;

FIG. 9 is a schematic block diagram of a data transmission apparatus provided by sonic embodiments of the present disclosure;

FIG. 10 is a schematic block diagram of another data transmission apparatus provided by some embodiments of the present disclosure; and

FIG. 11 is a schematic diagram of a storage medium provided by some embodiments of the present disclosure.

### DETAILED DESCRIPTION

In order to make objects, technical solutions and advantages of the embodiments of the present disclosure, the technical solutions of the embodiments of the present disclosure will be described clearly and completely in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The terms “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The present disclosure will be described below through several specific embodiments. In order to keep the following description of the embodiments of the present disclosure clear and concise, detailed description of known functions and known components may be omitted. When any component of the embodiments of the present disclosure appears in more than one drawing, the component is denoted by a same or similar reference number in each drawing.

Generally, data communication may suppress channel noise by adding scrambling code, however the introduction of the scrambling code reduces the transmission efficiency of valid data. For example, a VR (Virtual Reality) device is taken as an example for illustrating. Because the scrambling code is added in the process of data transmission, the amount of data in the display part is continuously increasing, so that the transmission amount of data is further expanded and the operation power consumption of the device is increased. Further, for the scrambling code added in the transmission process, an anti−interference part needs to be added in a peripheral interface (such as HDMI, DP) part, thereby further improving the operation loss of the peripheral interface. In addition, the computing ability of processing units in VR system is limited, and the introduction of the scrambling code increases the workload of the processing units, which is adverse to reducing the operation power consumption and manufacturing cost of the device, and is adverse to improving the response speed of the device.

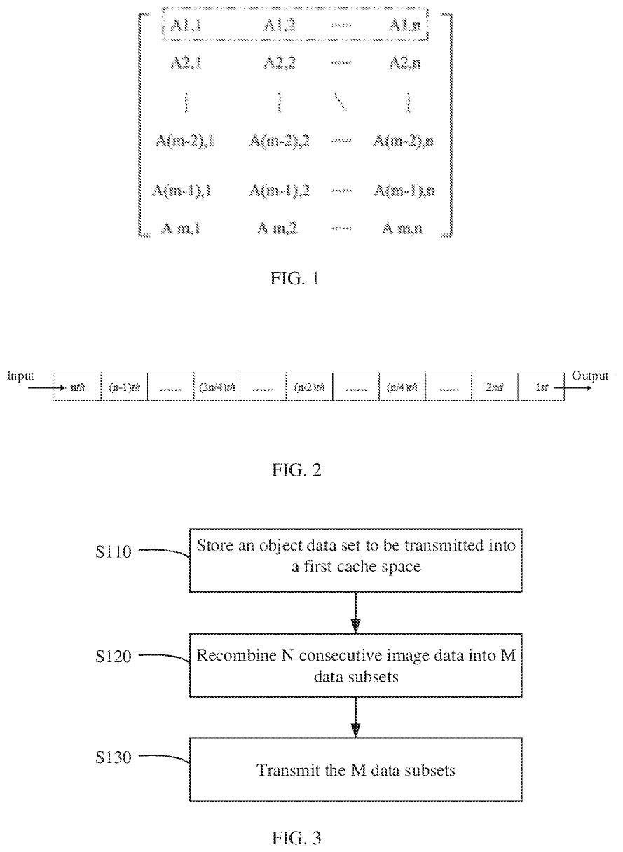

FIG. 1 is a matrix representation of pixel data of an image to be displayed. As illustrated in FIG. 1, a pixel data matrix of the image to be displayed includes m*n pixel data (e.g., including A1,1, A1,2, . . . , Am,n), respectively corresponding to pixels in m rows *n columns displayed in a display screen. For example, the m*n pixel data in the image to be displayed may be sequentially transmitted row by row in series and displayed on the display screen in a row-by-row scanning manner.

FIG. 2 is a schematic diagram of a serial data stream corresponding to the 1st row of pixel data illustrated in FIG. 1. For example, when performing row-by-row transmission, pixel data A1,1, A1,2, . . . , A1,n of the 1st row illustrated in FIG. 1 is sequentially sent one by one and stored in a row vector space illustrated in FIG. 2 so as to form a serial data stream of the 1st row as illustrated in FIG. 2: a first (1st) pixel data (i.e., A1,1.), a second (2nd) pixel data (i.e., A1,2), and a nth (nth) pixel data (i.e., A1,n). For example, in practical applications, two, three or more similar row vector spaces may be created so as to alternately store pixel data of adjacent rows in the pixel data matrix illustrated in FIG. 1, thereby meeting the period requirement of algorithm operations.

However, when pixel data is transmitted through the image data processing method illustrated in FIG. 2, since pixel data in adjacent addresses in the row vector space is consecutive, when data loss or damage occurs to the serial data stream in the row vector space because of the interference such as channel noise, the lost or damaged pixel data may be a certain part of consecutive data of the image to be displayed, so that, after data is transmitted through this method, the display data may be incomplete, thereby affecting the display quality of the display panel.

At least one embodiment of the present disclosure provides an image data processing method, which includes: storing an object data set to be transmitted into a first cache space, in which the object data set comprises N pieces of consecutive image data sequentially arranged in a first order, recombining the N pieces of consecutive image data into M data subsets, in which each data subset comprises N/M pieces of image data which are not adjacent to each other sequentially selected from the N pieces of consecutive image data according to a first rule, and transmitting the M data subsets. And M is an integer greater than 1, and N is an integer multiple of M and greater than M.

At least one embodiment of the present disclosure also provides a data transmission apparatus, an image display method and a storage medium corresponding to the image data processing method described above.

The image data processing method provided by the embodiments of the present disclosure, by changing the data transmission sequence in the data transmission process, may reduce the influences of the interference such as channel noise and the like on transmission data, so that there is no need to occupy additional transmission bandwidth, the quality of the data received at a signal receiving terminal is improved, and the implementation process is simpler, thereby simplifying the subsequent signal processing process, reducing the operation power consumption and manufacturing cost of the device, and improving the response speed of the device.

The embodiments of the present disclosure and examples thereof will be described in detail below with reference to the accompanying drawings.

FIG. 3 is a flowchart of an image data processing method provided by some embodiments of the present disclosure. The image data processing method may be implemented in software, hardware or a combination thereof. The image data processing method is loaded and executed by processors in devices such as mobile phones, notebook computers, virtual reality devices, augmented reality devices, desktop computers, network servers, digital cameras and the like. The image data processing method is used in the transmission process of image (frame) data, voice data and the like in order to change the data transmission sequence in the data transmission process, so that the effect of the interference such as channel noise and the like on transmission data is reduced, meanwhile, the quality of the data received at a signal receiving terminal may be improved, the subsequent signal processing operations such as filtering and the like may be simplified, and the operation power consumption of the device may be reduced. Image data is taken as an example for illustrating, but the embodiments of the present disclosure are not limited to this.

Next, an image data processing method provided by at least one embodiment of the present disclosure will be described with reference to FIG. 3. As illustrated in FIG. 3, the image data processing method includes steps S110 to S130.

Step S110: an object data set to be transmitted is stored into a first cache space.

Step S120: N pieces of consecutive image data are recombined into M data subsets.

Step S130: the M data subsets are transmitted.

For example, M is an integer greater than 1, and N is an integer multiple of M and greater than M.

For step S110, for example, the object data set comprises N pieces of consecutive image data sequentially arranged in a first order. For example, the N consecutive data is one row of image data. For example, in addition to the N consecutive data, the object data set may also include other data, e.g. data for expressing various information such as compression methods, sender identifications, etc. For example, the N consecutive data includes any one or more rows of pixel data of the image to be displayed illustrated in FIG. 1, and the following description takes the N consecutive data as pixel data A1,1, A1,2, of the 1st row as an example, and the embodiments of the present disclosure are not limited to this. For example, in this example, N=n. For example, the first order is the arrangement order of the first pixel data, the second pixel data, . . . , to the nth pixel data illustrated in FIG. 2.

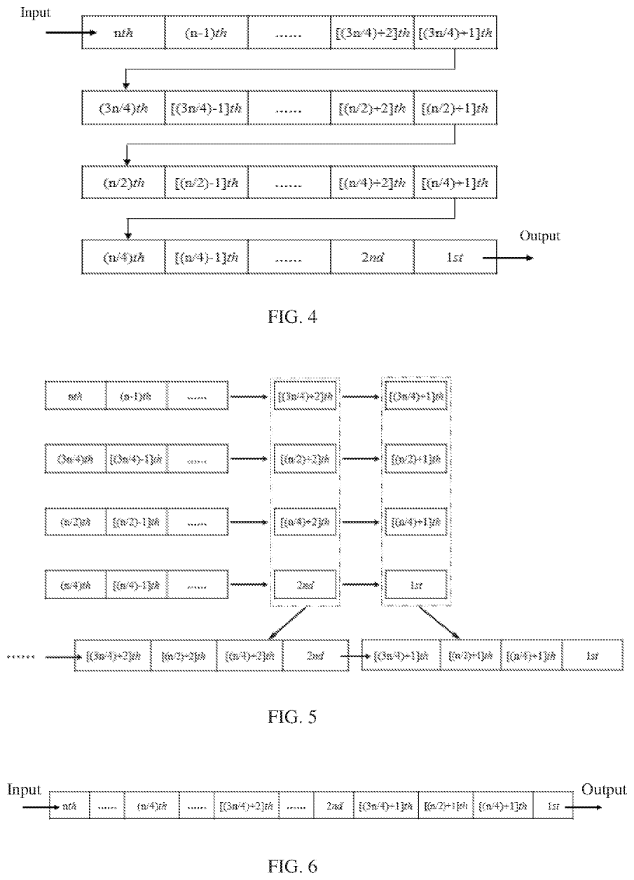

For example, the N consecutive data above is sequentially stored in the first cache space illustrated in FIG. 4 in the first order, in a serpentine manner as illustrated in FIG. 4. For example, the first data in the N consecutive data is the last one in the last row, and the nth data is the first one in the first row. For example, the first cache space is a matrix cache space, and the matrix cache space includes L*M (L is an integer greater than 1) data, that is, the N consecutive data is sequentially stored in a matrix cache space with L rows and M columns.

For example, by step S110, a row of data is stored as a matrix, which may be helpful to select data that is not adjacent to each other in subsequent steps for output in sequence.

For example, a cache unit may be provided and the object data set to be transmitted may be stored in the first cache space through the cache unit. For example, the cache unit may also be implemented by a central processing unit (CPU), an image processor (CPU), a tensor processor (TPU), a field programmable gate array (FPGA) or other forms of processing units having data processing capability and/or instruction executing capability and corresponding computer instructions.

For step S120, for example, each data subset comprises N/M data sequentially selected from the N pieces of consecutive image data according to a first rule, which is not adjacent to each other.

For example, an appropriate first rule may be selected so that N/M data which is not adjacent to each other may be sequentially selected from the N consecutive data. For example, the first rule includes: cyclically selecting the data subset with a period of L, that is, selecting L data as a data subset each time until all data is selected into the data subsets. Specifically, for example, data in a Mth column, a (M−1)th column, . . . , a (M−i)th column (i is an integer greater than 1. and less than M), and a 1st column of the matrix cache space is output sequentially in a column reverse order, and each column is taken as a data subset, respectively. For example, each column of data includes L (L=N/M) data that is not adjacent to each other, that is, a data subset may include a column of data in the matrix cache space, so that each piece of data in the data subset is not adjacent to each other.

As illustrated in FIG. 5, the rightmost column in the matrix cache space (including the 1st data, the [(n/4)+1]th data, the [(n/2)+1]th data and the [3n/4)+1]th data) is a Mth column, and analogized from right to left, is a (m−1)th column, . . . , a (M−i)th column, . . . , and a 1st column. For example, the 1st column is the leftmost column in the matrix cache space (including the (n/4)th data, the (n/2)th data, the (3n/4)th data, and the nth data).

It should be noted that other selection methods may also be used to select a data subset, as long as the period of cyclically selecting the data subset is L, and the embodiments of the present disclosure are not limited to this. For example, the data subset may also be selected in a stepped (oblique) manner, and 1 data arranged in a step is selected in each row. For example, in a case of L=4, the data subset may include the [(3n/4)+1]th data in the 1st row, the [(n/2)+2]th data in the 2nd row, the [(n/4)+3]th data in the 3rd row (not illustrated in the figures), the 4th data in the 4th row (not illustrated in the figures); alternatively, the data subset may include the nth data in the 1st row, the [(3n/4)−1]th data in the 2nd row, the [(n/2)−2]th data in the 3rd row (not illustrated in the figures), and the [(n/4)−3]th data in the 4th row (not illustrated in the figures).

The following takes a data subset including the data of the (M−i)th column in the matrix cache space as an example for illustrating. The data of the other columns is the same as this and will not be repeated.

For example, after the Lth data in the (M−i)th column is written into the matrix cache space, the data in the (M−i)th column is output in parallel. For example, when the data in the (M−i)th column is output in parallel, a parallel-to-serial conversion operation is performed on data in the [M−(i−1)]th column so as to convert the data in the [M−(i−1)]th column into serial data. For example, the Mth column and the (M−1)th column (i.e. the two columns in the dashed box in FIG. 5) will be taken as examples for introducing the process of data parallel output.

For example, as illustrated in FIGS. 4 and 5, the N consecutive pixel data is stored in the matrix cache space in a serpentine manner as illustrated in FIG. 4, at this time, pixel data is not sequentially output from the matrix cache space one by one. For example, considering the data in each column as an array, after the [(3n/4)+1]th element {A[(3n/4)+1],1} is stored in the matrix cache space, 4 lines of the Mth column simultaneously output the 1st, the [(n/4)+1]th, the [(n/2)+1]th and the [(3n/4)+1]th data in parallel, i.e. the 4 data {A1,1}, {A[(n/4)+1],1}, {A[(n/2)+1],1} and {A[(n3/4)+1],1} in the array is simultaneously output, and after the [(3n/4)+2]th element {A[(3n/4)+2],1} is stored in the matrix cache space, 4 lines of the (M−1)th column simultaneously output the 2nd, the [(n/4)+2]th, the [(n/2)+2]th and the [(3n/4)±2]th data in parallel, i.e. the 4 data {A2,1},{A[(n/4)+2],1}, {A [(n/2)+2],1} and {A[(n3/4)+2]1 } in the array is simultaneously output, and so on.

As illustrated in FIG. 5, the 4 data of the (M−1)th column is output in parallel, meanwhile, a parallel-to-serial conversion operation is performed on the 4 data of the Mth column which is output in parallel, that is, the output of the (M−1)th column and the parallel-to-serial conversion operation of the Mth column are simultaneously performed, and any other two adjacent columns of data meets this rule, For example, after the parallel-to-serial conversion operation is performed on the 4 pixel data of the Mth column which is output in parallel, a horizontal serial data stream as illustrated in FIG. 5 is formed, so that pixel data which is not adjacent to each other may be sequentially output one by one.

For example, when data loss or transmission error occurs to the serial data stream transmitted through the above steps because of the interference such as channel noise and the like, since the transmitted pixel data is not adjacent to each other, the pixel data with transmission error or the lost pixel data is spaced pixel data instead of consecutive pixel data, thus the pixel data with transmission error or the lost pixel data may be recovered according to pixel data located in the address unit which is not lost in the original image and is adjacent to it. For example, by performing a mathematical fitting calculation on the pixel data adjacent to it, such as interpolation or the like, the data with transmission error is modified or the lost data is filled, similar to RGB (YCbCr4:4:4) converted to YCbCr4:2:0. Because the discrimination ability of human eyes is limited, a small part of differences do not damage the sensory impression of a picture. Therefore, this method does not affect the display effect of an image substantially, thereby reducing the influences caused by the interference such as channel noise in the process of data transmission and improving the display quality of the display panel.

For example, M represents an actual number of interleaved data, and M−1 represents intervals of the interleaved data. For example, when M=10 and N=n=40, each row of the first cache space illustrated in FIG. 4 includes 10 data, and M−1=9 data (i.e., the 2nd to (n/4)th (i.e., the 10th data)) is spaced between the first (1st) data and the [(n/4)+1]th (i.e., the 11th) data. For example, when one data is lost between the 1st data and the [(n/4)+1]th data, i.e. the intervals of the interleaved data becomes 8, then the [(n/4)+2]th (i.e. the 12th) data will be written into the position of the [(n/4)+1]th data, and so on . . . , thus causing confusion when the data subsets are selected. Therefore, by monitoring the intervals of the interleaved data, it is ensured that the intervals of data addresses in each row are correct, so that the data subsets may be selected orderly, and the normal reading of pixel data may be ensured.

For example, a data subset selecting unit may be provided, and the N consecutive data is recombined into the M data subsets through the data subset selecting unit. For example, the data subset selecting unit may also be implemented by a central processing unit (CPU), an image processor (GPU), a tensor processor (TPU), a field programmable gate array (FPGA) or other forms of processing units having data processing capability and/or instruction executing capability and corresponding computer instructions.

For step 5130, for example, the M data subsets may be transmitted in serial or parallel.

FIG. 6 is a schematic diagram of serial transmission of M data subsets provided by some embodiments of the present disclosure. For example, the M data subsets which are output in parallel illustrated in FIG. 5 are sequentially converted into serial data streams respectively through the parallel-to-serial conversion operation and then transmitted, thereby forming a serial data stream with inconsecutive addresses as illustrated in FIG. 6. For example, the serial data stream includes the above N data, but the addresses of the N data are arranged in the order of the selected M data subsets. For example, this serial data stream is transmitted to a signal receiving terminal, e.g., a second cache space. For example, in an example, in a VR system, the sending terminal of the serial data stream is an AP (Application Processor) and the signal receiving terminal is a driving circuit of a display panel.

For example, a transmitting unit may be provided, and the M data subsets may be transmitted through the transmitting unit. For example, the transmitting unit may be a wired unit or a wireless transmitting unit. The wired transmission may be an electrical signal transmission apparatus or an optical signal transmission apparatus, the electrical signal transmission apparatus transmits data through, for example, a coaxial cable, and the optical signal transmission apparatus transmits data through, for example, an optical fiber, and they are based on respective related data transmission standards, such as synchronous digital hierarchy (SDH), dense wavelength division multiplexing (DWDM), etc. The wireless transmitting unit may be wireless communication apparatus based on various standards, such as WIFI, Bluetooth, ZigBee, infrared, 2G/3G/4G/5G mobile communication, etc. For example, the transmitting unit includes a central processing unit (CPU), an image processor (CPU), a tensor processor (TPU), a field programmable gate array (FPGA) or other forms of processing units having data processing capability and/or instruction execution capability, and corresponding computer instructions.

The image data processing method provided by the above embodiments of the present disclosure, by changing the data transmission sequence in the data transmission process, may reduce the influences of the interference such as channel noise and the like on transmission data, so that there is no need to occupy additional transmission bandwidth, the quality of the data received at a signal receiving terminal is improved, and the implementation process is simpler, thereby simplifying the subsequent signal processing process, reducing the operation power consumption and manufacturing cost of the device, and improving the response speed of the device.

FIG. 7 is a flowchart, of another image data processing method provided by some embodiments of the present disclosure. As illustrated in FIG. 7, the image data processing method provided by some embodiments of the present disclosure may also read and check the transmitted data subsets, and fill and modify the transmitted data according to the check result. As illustrated in FIG. 7, the image data processing method further includes steps S140 to S170. Next, the image data processing method will be described with reference to FIG 7.

Step S140: the transmitted M data subsets are received and data included in each of the M data subsets is extracted to a second cache space.

For example, the N consecutive data sequentially arranged in the first order is recovered based on the first rule in the second cache space, for example, such that the arrangement orders of the stored data in the second cache space and the first cache space are the same. For example, the second cache space is a matrix cache space and is the same as the first cache space. For example, this step is similar to decoding the serial data stream formed in the above steps S120 and S130 so as to recover it to the N consecutive data sequentially arranged in the first order, for example, as the arrangement in the matrix cache space. illustrated in FIG. 4. For example, at a signal outputting terminal, the corresponding pixel data is read to the corresponding position according to the arrangement rule before the data transmission. Therefore, although the image data processing method of the embodiments of the present disclosure changes the transmission sequence of data, the transmitted pixel data may be read to an original position through dynamic addressing, so that the display content of the display panel is not affected, and the display quality of the display panel is improved.

For example, a reading unit may be provided and the transmitted M data subsets are received through the reading unit, and data included in each of the M data subsets is extracted to a second cache space. For example, the reading unit may also be implemented by a central processing unit (CPU), an image processor (CPU), a tensor processor (TPU), a field programmable gate array (FPGA) or other forms of processing units having data processing capability and/or instruction executing capability and corresponding computer instructions.

Step S150: each piece of data in the second cache space is checked.

In the transmission process, because of the existence of the interference such as channel noise, the situation of data transmission error (a certain byte changes from 1 to 0, or from 0 to 1) or data loss may occur, so it is necessary to check the transmitted data (i.e. the data in the second cache space). For example, the check may be performed based on various data check methods, such as parity check, Homming check, cyclic redundancy code (CRC) check, etc. For example, the check may also be performed by comparing the data in the second cache space with the original data (e.g., the data in the first cache space) and then determining whether they are the same.

For example, a checking unit may be provided, and each piece of data in the second cache space is checked by the checking unit. For example, the checking unit may also be implemented by a central processing unit (CPU), an image processor (CPU), a tensor processor (TPU), a field programmable gate array (FPGA) or other forms of processing units having data processing capability and/or instruction executing capability and corresponding computer instructions.

Step S160: it is determined that whether there is data with transmission error or lost data in the second cache space, and if so, step S170 is performed.

For example, according to the data check result in step S150, it may be determined whether the situation of data transmission error or data loss occurs. For example, if the data in the second cache space is different from the original transmission data, it indicates that transmission error occurs in the transmission process of data. If the data in the second cache space is less than the original data, it indicates that the corresponding data is lost in the data transmission process.

Step S170: the data with transmission error is modified or the lost data is filled according to an interpolation method.

Since the transmitted pixel data is not adjacent to each other, the data with transmission error or the lost pixel data is spaced pixel data instead of consecutive pixel data, thus the pixel data with transmission error or the lost pixel data may be recovered according to pixel data located in the address unit which is not lost in the original image and is adjacent thereto. For example, by performing a mathematical fitting calculation on the pixel data adjacent to it, such as interpolation or the like, the data with transmission error is modified or the lost data is filled, so that the influences caused by the interference such as channel noise in the process of data transmission is reduced and the display quality of the display panel is improved. For example, when error occurs to a certain item of data, the arithmetic average of a previous item of data and a following item of data which are adjacent to the item of data is assigned to the item of data, and the new data is used for subsequent display operations.

For example, after the N consecutive data sequentially arranged in the first order is recovered based on the first rule in the second cache space, or after the above step S170, in order to perform display operations, it may further include: filtering the N consecutive data.

For example, commonly used filtering methods such as Gaussian filtering and median filtering may be used to filter the received data, thereby weakening the noise generated in the transmission process, improving the quality of the display data, and thus improving the display quality of the display panel.

It should be noted that in the embodiments of the present disclosure, flows of the image data processing method may include more or less operations, which may be performed sequentially or in parallel. Although the flows of the image data processing method described above include a plurality of operations appearing in a particular order, it should be clearly understood that the order of the plurality of operations is not limited. The image data processing method described above may be performed once, also may be performed multiple times according to predetermined conditions.

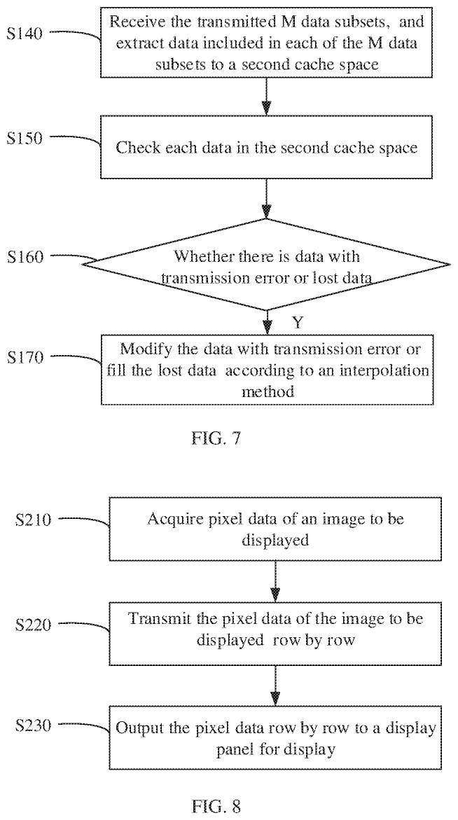

FIG. 8 is a flowchart of an image display method provided by some embodiments of the present disclosure. For example, as illustrated in FIG. 8, the image display method includes steps S210 to S230. Next, the image display method will be described with reference to FIG. 8.

Step S210: pixel data of an image to be displayed is acquired.

For example, the pixel data matrix of the image to be displayed includes m*n pixel data (e.g., includes pixel data A1,1, A1,2, . . . , Am,n as illustrated in FIG. 1).

Step S220: the pixel data of the image to be displayed is transmitted row by row.

For example, the pixel data of the image to be displayed may be transmitted row by row through the above-mentioned steps S110 to S170, so that the influences caused by the interference such as channel noise and the like in the data transmission process may be reduced. After each row of data is received and cached by a data driving circuit of a display panel, it is applied to one row of pixel cells for display in a row-by-row scanning display operation of the display panel, thereby obtaining higher display quality. The specific image data processing method may refer to the detail description of the above steps S110 to S170, and will not be repeated here.

Step S230: the pixel data is output row by row to a display panel for display.

For example, in step S220, the pixel data is transmitted row by row to the data driving circuit of the display panel. After a row of data signals are received and cached by the data driving circuit, the pixel data is output row by row to the corresponding row of pixel cells so as to implement the respective display of the display panel.

The technical effect of the image display method provided by the above embodiments of the present disclosure may refer to the technical effect of the image data processing method provided by the embodiments of the present disclosure and will not be repeated here.

FIG. 9 is a schematic block diagram of a data transmission apparatus provided by some embodiments of the present disclosure. For example, in an example illustrated in FIG. 9, the data transmission apparatus 100 includes a cache unit 110, a data subset selecting unit 120 and a transmitting unit 130. For example, these units may be implemented by hardware (e.g., circuit) modules or software modules, etc.

The cache unit 110 is configured to store an object data set to be transmitted into a first cache space. For example, the object data set comprises N consecutive data sequentially arranged in a first order. For example, the cache unit 110 may implement step S110, and its specific implementation method may refer to the relevant description of step S110, which will not be repeated here.

The data subset selecting unit 120 is configured to recombine N pieces of consecutive image data into M data subsets. For example, each data subset comprises N/M pieces of image data which are not adjacent to each other, sequentially selected from the N consecutive data according to a first rule. For example, the data subset selecting unit 120 may implement step S120, and its specific implementation method may refer to the relevant description of step S120 and will not be repeated here.

The transmitting unit 130 is configured to transmit the M data subsets. For example, the transmitting unit 130 may implement step S130, and its specific implementation method may refer to the relevant description of step S130, which will not be repeated here.

For example, in another example, the data transmission apparatus 100 further includes a reading unit and a checking unit (not illustrated in the figures).

For example, the reading unit is configured to receive the transmitted M data subsets, and extract data included in each of the M data subsets to a second cache space. For example, the N consecutive data sequentially arranged in the first order is recovered based on the first rule in the second cache space. For example, the reading unit may implement step S140, and its specific implementation method may refer to the relevant description of step S140, which will not be repeated here.

The checking unit is configured to check each piece of image data in the second cache space, after the N consecutive data sequentially arranged in the first order is recovered based on the first rile in the second cache space. For example, if data with transmission error or lost data occurs, the data with transmission error may be modified or the lost data may be filled according to an interpolation method. For example, the checking unit may implement steps S150 to S170, and the specific implementation method may refer to the relevant description of steps S150 to S170, which will not be repeated here.

It should be noted that in the data transmission apparatus provided by the embodiments of the present disclosure, more or fewer circuits or units may be included, and a connection relationship between each circuit or unit is not limited and may be determined according to actual requirements. The specific configuration of each circuit is not limited, and each circuit may be composed of analog devices, digital chips, or other applicable manners according to circuit principles.

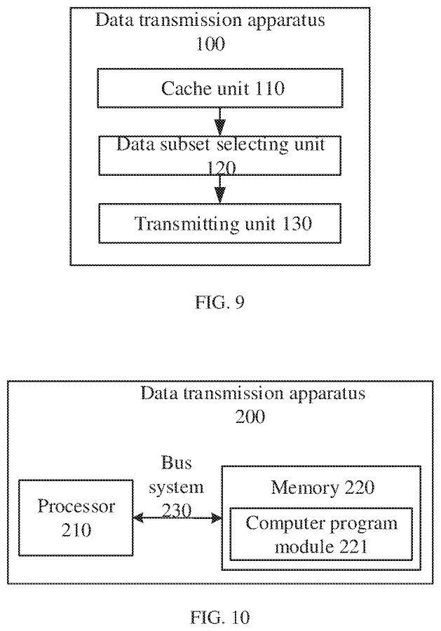

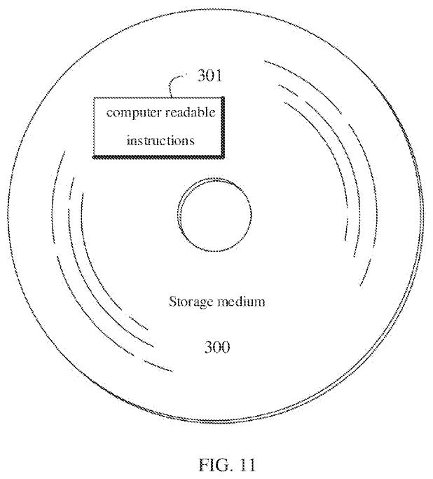

FIG. 10 is a schematic block diagram of another data transmission apparatus provided by some embodiments of the present disclosure. As illustrated in FIG. 10, the data transmission apparatus 200 includes a processor 210, a memory 220, and one or more computer program modules 221.

For example, the processor 210 and the memory 220 are connected through a bus system 230. For example, one or more computer program modules 221 are stored in the memory 220. For example, one or more computer program modules 221 include instructions for executing the image data processing method provided by any embodiment of the present disclosure. For example, instructions in one or more computer program modules 221 may be executed by the processor 210. For example, the bus system 230 may be a common serial or parallel communication bus, and the embodiments of the present disclosure are not limited to this.

For example, the processor 210 may be a central processing unit (CPU), an image processor (GPU), or other forms of processing units having data processing capability and/or instruction executing capability, may be a general purpose processor or a special purpose processor, and may control other components in the data transmission apparatus 200 for performing desired functions.

The memory 220 may include one or more computer program products, which may include various forms of computer readable storage media, such as a volatile memory and/or non-volatile memory. The volatile memory may include, for example, memory (RAM) and/or cache, etc. The non-volatile memory may include, for example, read only memory (ROM), hard disk, flash memory, etc. One or more computer program instructions may be stored on a computer readable storage medium, and the processor 210 may execute the program instructions so as to implement functions in the embodiments of the present disclosure (implemented by the processor 210) and/or other desired functions, such as image data processing methods, etc. Various application programs and various data may also be stored in the computer readable storage medium, e.g., various data subsets and various data used and/or generated by the application programs.

It should be noted that, for clarity and conciseness, the embodiments of the present disclosure do not provide all components of the data transmission device 200. In order to realize the necessary functions of the data transmission apparatus 200, those skilled in the art may provide and set other components not illustrated, according to specific requirements, and the embodiments of the present disclosure are not limited to this.

The technical effect of the data transmission apparatus 100 and the data transmission apparatus 200 in different embodiments may refer to the technical effect of the image data processing method provided by the embodiments of the, present disclosure, which will not be repeated here.

Some embodiments of the present disclosure also provide a storage medium. FIG. 11 is a schematic diagram of a storage medium provided by some embodiments of the present disclosure. For example, a storage medium 300 non-transitorily stores computer readable instructions 301, which when executed by a computer (including a processor), may perform the image data processing method provided by any embodiment of the present disclosure.

For example, the storage medium may be any combination of one or more computer readable storage media. For example, one computer readable storage medium contains computer readable program code which stores an object data set to be transmitted into a first cache space, and another computer readable storage medium contains computer readable program code which extracts M data subsets. For example, when the program code is read by a computer, the computer may execute the program code stored in the computer storage medium for performing, for example, the image data processing method provided by any embodiment of the present disclosure.

For example, the storage medium may include a memory card of a smart phone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, or any combination of the above storage media, or other applicable storage media.

For the present disclosure, the following statements should be noted:

(1) The accompanying drawings involve only the structure(s) in connection with the embodiment(s) of the present disclosure, and for other structure(s), reference can be made to common design(s).

(2) The embodiments of the present disclosure and features in the embodiments may be combined with each other to obtain new embodiments if they do not conflict with each other.

The above description is only an exemplary implementation of the present disclosure, but the scope of the present disclosure is not limited to this, and the scope of the present disclosure is defined by the accompanying claims.

1-15. (canceled)

16. An image data processing method, comprising:
storing an object data set to be transmitted into a first cache space, wherein the object data set comprises N pieces of consecutive image data sequentially arranged in a first order;
recombining the N pieces of consecutive image data into M data subsets, wherein each data subset comprises N/M pieces of image data which are not adjacent to each other, sequentially selected from the N pieces of consecutive image data according to a first rule; and
transmitting the M data subsets; and
wherein M is an integer greater than 1, and N is an integer multiple of M and greater than M.

17. The image data processing method according to claim 16, wherein the N pieces of consecutive image data sequentially arranged in the first order comprises N pieces of consecutive image data sequentially arranged in an order from a 1st piece to an Nth piece.

18. The image data processing method according to claim 16, further comprising:
receiving the transmitted M data subsets, and extracting image data included in each of the M data subsets to a second cache space, and
wherein the N pieces of consecutive image data sequentially arranged in the first order is recovered based on the first rule in the second cache space.

19. The image data processing method according to claim 17, further comprising:
receiving the transmitted M data subsets, and extracting image data included in each of the M data subsets to a second cache space, and
wherein the N pieces of consecutive image data sequentially arranged in the first order is recovered based on the first rule in the second cache space.

20. The image data processing method according to claim 18, wherein after the N pieces of consecutive image data sequentially arranged in the first order is recovered based on the first rule in the second cache space,
each piece of data in the second cache space is checked, and if there is any image data with transmission error or lost image data occurs, the image data with transmission error is modified or the lost image data is filled according to an interpolation method.

21. The image data processing method according to claim 19, wherein after the N pieces of consecutive image data sequentially arranged in the first order is recovered based on the first rule in the second cache space,
each piece of data in the second cache space is checked, and if there is any image data with transmission error or lost image data occurs, the image data with transmission error is modified or the lost image data is filled according to an interpolation method.

22. The image data processing method according to claim 16, wherein the first rule comprises: cyclically selecting the data subset with a period of L, where L is an integer greater than 1.

23. The image data processing method according to claim 22, wherein the first cache space is a matrix cache space, and the matrix cache space comprises L*M pieces of image data.

24. The image data processing method according to claim 23, wherein selecting cyclically the data subset with the period of L comprises:
in a column reverse order, outputting sequentially image data in a Mth column, a (M−1)th column, . . . , a (M−i)th column, . . . , and a 1st column of the matrix cache space as the data subset, respectively;
wherein each column comprises L pieces of image data which are not adjacent to each other, and
wherein i is an integer greater than 1 and less than M.

25. The image data processing method according to claim 24, wherein after Lth image data in the (M−i)th column is written into the matrix cache space, image data in the (M−i)th column is output in parallel.

26. The image data processing method according to claim 24, wherein when the image data in the (M−i)th column is output in parallel, a parallel-to-serial conversion operation is performed on image data in a [M−(i−1)]th column so as to convert the image data in the [M−(i−1)]th column into serial data.

27. The image data processing method according to claim 25, wherein when the image data in the (M−i)th column is output in parallel, a parallel-to-serial conversion operation is performed on image data in a [M−(i−1)]th column so as to convert the image data in the [M−(i−1)]th column into serial data.

28. An image display method, comprising:
acquiring pixel data of an image to be displayed;
transmitting the pixel data of the image to be displayed row by row according to the image data processing method of claim 16; and
outputting the pixel data row by row to a display panel for display.

29. A data transmission apparatus, comprising:
a cache unit, configured to store an object data set to be transmitted into a first cache space, wherein the object data set comprises N pieces of consecutive image data sequentially arranged in a first order;
a data subset selecting unit, configured to recombine N pieces of consecutive image data into M data subsets, wherein each data subset comprises N/M pieces of image data which are not adjacent to each other, sequentially selected from the N pieces of consecutive image data according to a first rule; and
a transmitting unit, configured to transmit the M data subsets; and
wherein M is an integer greater than 1, and N is an integer multiple of M and greater than M.

30. The data transmission apparatus according to claim 29, further comprising:
a reading unit, configured to receive the transmitted M data subsets, and extract image data included in each of the M data subsets to a second cache space, and wherein the N pieces of consecutive image data sequentially arranged in the first order is recovered based on the first rule in the second cache space.

31. The data transmission apparatus according to claim 30, further comprising:
a checking unit, configured to check each piece of image data in the second cache space, after the N pieces of consecutive image data sequentially arranged in the first order is recovered based on the first rule in the second cache space, and to modify image data with transmission error or fill lost image data according to an interpolation method if there is any image data with transmission error or lost image data occurs.

32. A data transmission apparatus, comprising:
a processor;
a memory; and
one or more computer program modules stored in the memory and configured to be executed by the processor, wherein the one or more computer program modules comprise instructions for implementing the image data processing method according to claim 16.

33. A storage medium storing non-transitorily computer readable instructions that, when executed by a computer, cause the computer to perform the instructions of the image data processing method according to claim 16.
